(19) United States
(12) Patent Application Publication
(10) Pub. No.: US 2006/0254098 A1
(43) Pub. Date: Nov. 16, 2006

(54) Flower blooming simulative toy flower

(76) Inventor: Cheung Yat Fu, Kwung Tong (HK)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/200,245

(22) Filed: Aug. 9, 2005

(30) Foreign Application Priority Data
May 10, 2005 (CN) 200520058191.3

(51) Int. Cl. G09F 19/08

(52) U.S. Cl. 40/411

(57) ABSTRACT

The present Utility Model is proposed to provide a flower blooming simulative toy flower, including flower petal and base, a micro-motor and a PCB board is fixed within the base, the micro-motor is electrically connected with the PCB board, the flower petal is fixed up to the flower petal clamp, the flower petal clamp is hinge connected with a end of rigid push-pull rod, and the other end of rigid push-pull rod is co-motional with the output shaft of said micro-motor via a driving unit. The present Utility Model applies a linear micro-motor brought along by the shape memory alloy movement drives the flower petal to open/close. The opening & closing speed and angle of flower petal are controlled precisely by the central processor, the speed and angle could be set to various coordination state, the opening speed of flower petal may fast or slow, the opening angle may be large or small and may be positioned at all times, it is thus more flexible and vividly compared with the current toys controlled by micro-motor and reset by mechanism. The present Utility Model is of low manufacturing cost, compact size, low selling price & noise, and a higher movement controllability. According to the present Utility Model, the actions of grass, leaf or other plant could also be simulated with the same verisimilitude.

### FIELD OF INVENTION

The present Utility Model relates to a toy, especially relates to a biotic action simulative toy.

### BACKGROUND OF THE INVENTION

The current toys present various styles with fine appearances and improved dynamic properties to attract more consumer attentions. The electric toys, which simulate the movements of human or animal and plant, could attract more consumer attentions and are thus more popular than static toy in virtue of their “dynamic” effect. This kind of electric toys are equipped generally with the micro-electromagnetic motor, the movement produced by the traditional electromagnetic motor, however, is very mechanical and without sufficient verisimilitude, and the difficulty in movement positioning is hence existed. Moreover, since the toy movement is generally controlled by the inset micro processor and the electromagnetic motor will consume large power with a surge wave, so it is not suitable to connect directly with the micro processor. Even the advanced motor, such as the linear motor or controllable step motor, isn't applied to the electric toy for its big volume and high cost.

### SUMMARY OF THE INVENTION

The present Utility Model is proposed to provide a flower blooming simulative toy flower with controllable movement speed, controllable range and sufficient verisimilitude.

To achieve the above aim, the technical proposal of the present Utility Model is as follows: a flower blooming simulative toy flower, including flower petal and base, characterized in that: a micro-motor and a PCB board is fixed within the base, the micro-motor is electrically connected with the PCB board, the flower petal is fixed up to the flower petal clamp, the flower petal clamp is hinge connected with a end of rigid push-pull rod, and the other end of rigid push-pull rod is co-motional with the output shaft of said micro-motor via a driving unit.

According to the present Utility Model, a linear micro-motor brought along by the shape memory alloy movement drives the flower petal to open/close. The shape memory alloy has a special property of being extendible stretched with little force in initial, just like pulling a rubber ring with hand. The linear shape memory alloy, however, doesn't return back to its initial length after removing the external force, but keeps the stretched state until turning on power again and then returns back to the initial length. The linear micro-motor brought along by the shape memory alloy movement makes use exactly this alloy property to transfer the alloy linear expanding & contracting into the shaft rotating output, and the opening & closing speed and angle of flower petal are controlled precisely by the central processor, the speed and angle could be set to various coordination state, the opening speed of flower petal may fast or slow, the opening angle may be large or small and may be positioned at all times, it is thus more flexible and vividly compared with the current toys controlled by micro-motor and reset by mechanism. Because the motor doesn't need additional parts, such as the gear set and complicated mechanism system that transfer the rotation movement into linear movement, comparing with the electromagnetic motor of same power, the manufacture cost according to present Utility Model just takes a fraction part of the electromagnetic motor with a compact structure, low cost & noise, and a higher movement controllability. According to the present Utility Model, the actions of grass, leaf or other plant could also be simulated with the same verisimilitude.

### BRIEF DESCRIPTION OF THE DRAWING

FIG. 1 is a contour figure of present Utility Model.

FIG. 2 is an internal structure figure of present Utility Model.

FIG. 3 is a connecting units structure figure.

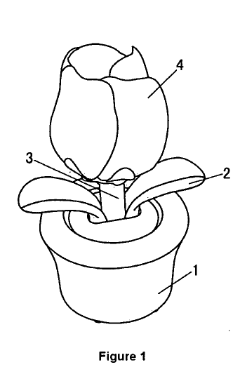

### DETAILED DESCRIPTION OF THE INVENTION

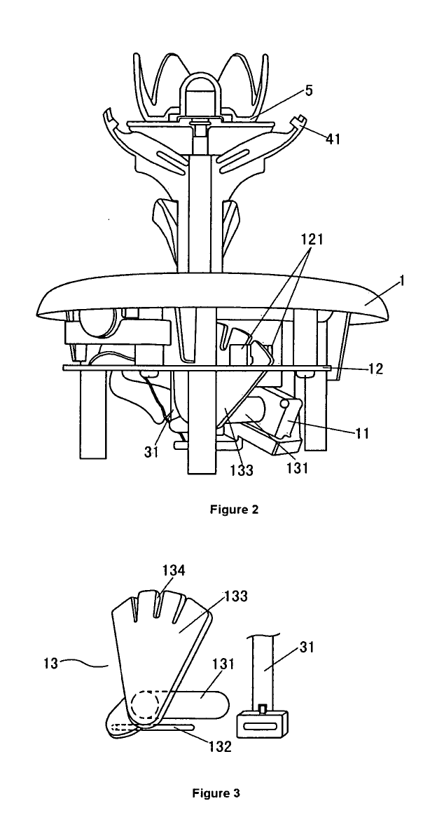

The toy flower shown as FIG. 2 and FIG. 3 is composed of base 1 (flowerpot), flower stem 2, floral leaf 3, flower petal 4 and flower center 5 within the flower petal center. With the flowerpot case opened, the flowerpot base internal structure shown as FIG. 2 is revealed. A micro-motor 11, a PCB integrated circuit board 12 and a group of waggling rods 13 are inset within the base 1. The micro-motor 11 is fixed within base 1 and connected electrically to the PCB board 12. As FIG. 3 shows, the waggling rod 13 includes the input tube 131 and output rod 132, and fixed parallel to the positioning segment 133. The input tube 131 is overlap connected to the output shaft outside of micro-motor 11, rotates along the output shaft rotating, and drives the segment 133 and input tube 132 to rotate together.

As FIG. 3 shows, flower stem 3 is central empty, with a rigid push-pull rod 31 inset in it, more flower petal clamps 41 are hinged at the top of rigid push-pull rod 31, a groove 32 is set at the bottom of the rigid push-pull rod 31, and the movable end of output rod 132 is set within the groove 32. In case of the output rod 132 being swing up and down, the push-pull rod 31 will be driven to shift up and down.

One end of flower petal clamp 41 is hinged to the push-pull rod 31, and the other end is clamping each flower petal 4. The fixed flower center 5 is set at the flower petal 4 center, and the flower petal clamp 41 is connected against to the flower center base. When the push-pull rod 31 lifts up, the flower petal clamp 41 will rotate with the contact point upon the flower center base as the pivot point to open the flower petal outwardly. Otherwise, in case of the push-pull rod 31 falls down, the fix end of flower petal clamp 41 and flower petal 4 will turn upwardly to close the flower petal 4 inwardly.

According to the present Embodiment, the flower petal opening angle is controlled by a photoelectric feedback system via the swing angle controlling of waggling rod. In concrete, at least one positioning slot 134 is made onto the positioning segment 133 for passing through light, as FIG. 3 in this embodiment shows, 3 positioning slots are made. A pair of transceiver photocell 121 is electrically connected onto the PCB board 12 and positioned separately at both side of positioning segment 133. When the positioning segment 133 of waggling rod 13 turns to the position at which the positioning slot aligns with the transceiver photocell 121 at its two sides, the light pass through the positioning slot 134 from left to right, the photoelectric signal will arrive to the PCB board 12 and result in a current variation at this time.

A luminous unit is set within the flower center 5, it may be a lamp, a diode or other luminous part.

An acoustic controlled switch is electric connected to the PCB board 12, it receives the acoustic command, starts the motor and drives the flower petal to close/open.

According to the present Utility Model, the micro-motor is a kind of linear micro-motor manufactured by U.S Nanomuscle Company, which is driven by the shape memory alloy movement.

A power switch is set onto the flowerpot base 1, in case of the switch is on, the flower petal accepts the command to close/open. The actions according to the present Utility Model will be explained in detail with reference of the accompanying figures.

(A) Initial Static State

At initial, the toy flower is in power-off state, motor 11 doesn't work, the shape memory metal within motor 11 is in standstill state, both waggling rod 13 and push-pull rod 31 is motionless, and the flower petal is closed at this time.

(A) Flower Blooming

In case of the music or other sound existing in surroundings reaches to a certain sound pressure, the acoustic controlled switch receives that, and signal is transferred to micro-motor 11 via PCB board 12 to turn the motor 11. The motor 11 drives the input tube 131 of waggling rod 13 through its output shaft to swing upward the output rod 132 of waggling rod. The moving end of output rod 132 is inserted in the groove at bottom of push-pull rod 31 to push the push-pull rod 31 upward. The flower petal clamp 41 hinged at top of push-pull rod 31 turns downward on restriction of the flower center base to open the flower petal 4 outward. The opening speed of flower petal 4 is controlled from the PCB integrated circuit board.

In case of current varying, the shape memory metal receives force and loses balance, its length changes, the linear movement is converted to the output shaft rotating by motor to drive the waggling rod and push-pull rod, and the flower petal is opened gradually.

(C) The Angle Controls of the Flower Petal Opening

A positioning slot 134 is made every an angle, such as 150, on the positioning segment 133, for purpose of the positioning controlling of flower petal open range. The PCB board 12 issues a command to the controlling circuit if the flower petal is needed to open and keep at a certain angle. When the positioning segment 133 of waggling rod 13 turns to the position at which the positioning slot corresponding to the flower petal opening angle aligns with the transceiver photocell 121 at its both side, the light pass through the positioning slot 134 from left to right, the transceiver photocell 121 sends the received photoelectric signal to the PCB board 12 to stabilize the current, at this time, the metal deforming tension of the shape memory metal itself is balanced with the spring elastic force, its length doesn't change any more, both waggling rod and push-pull rod is motionless, and the flower petal is stationary opened at a certain angle.

(D) Flower Closing

When the PCB board 12 issues a motor stopping signal, the motor 11 will be powered-off, at this time, the shape memory metal is pulled back to the original form under the elastic force of reset spring, the motor output shaft rotates in diverse direction, drives the waggling rod 13 to rotates in diverse direction also, and moves the push-pull rod 31 downward, the flower petal clamp 41 turns upward and the flower petal 4 closes inward.

The speed of flower petal opening or closing is controlled from the central processor also. The central processor sets the current variation to vary the speed of flower petal opening/closing.

According to the present Utility Model, a pair of transceiver photocells receives and transmits the photo-electric signal to control the flower petal opening angle, the application, however, isn't limited to this, the aim may be achieved also by other mechanical feedback system or electric feedback system etc. The controlling of flower opening angle and speed according to the present embodiment is merely the most simple mode and shouldn't be limited by this in application, more combined modes are possible by way of integrated circuit controlling.

We claim:

1. A flower blooming simulative toy flower, including flower petal and base, characterized in that: a micro-motor and a PCB board is fixed within the base, the micro-motor is electrically connected with the PCB board, the flower petal is fixed up to the flower petal clamp, the flower petal clamp is hinge connected with a end of rigid push-pull rod, and the other end of rigid push-pull rod is co-motional with the output shaft of said micro-motor via a driving unit.

2. The simulative toy flower according to claim 1, characterized in that: the said micro-motor is a linear micro-motor driven by the shape memory alloy.

3. The simulative toy flower according to claim 1, characterized in that: including further a photoelectric feedback system controlling the flower petal opening angle, which is connected with said PCB board.

4. The simulative toy flower according to claim 3, characterized in that: the said photoelectric feedback system includes a positioning segment which is co-motional with said driving unit, and a pair of transceiver photocell positioned separately at the both side of positioning segment, at least one positioning slot is made onto the said positioning segment for passing through light.

5. The simulative toy flower according to claim 4, characterized in that: the said driving unit is a group of waggling rod, including a input tube and a output rod, which is parallel fixed to the said positioning segment, the input tube is connected co-axially to said micro-motor output shaft, and the output rod is co-motional with the said rigid push-pull rod.

6. The simulative toy flower according to claim 1, characterized in that: there is a fixed flower center in middle of the said flower petal, the said flower petal clamp is connected against to the flower center base.

7. The simulative toy flower according to claim 4, characterized in that: there is a luminous unit in the said flower center.
